(19) United States
(12) Patent Application Publication
(10) Pub. No.: US 2020/0378538 A1
(43) Pub. Date: Dec. 3, 2020

(54) PIPE CONNECTING STRUCTURE

(71) Applicant: Xiamen Forbetter Sanitary Ware Co., Ltd., Xiamen (CN)

(72) Inventors: Xiliang Yan, Xiamen (CN); Yihui Chen, Xiamen (CN)

(21) Appl. No.: 16/425,937

(22) Filed: May 29, 2019

(51) Int. Cl. F16L 37/04

(52) U.S. Cl. CPC F16L 37/04

(57) ABSTRACT

A pipe connecting structure for joining a first pipe having a limiting groove includes a second pipe and a limiting member. The second pipe is provided with a second connecting portion. The second connecting portion is provided with a receiving hole for receiving the first pipe. The limiting member is sleeved on the second connecting portion and is provided with a limiting protrusion. The limiting protrusion is inserted through the second connecting portion to be connected to the first pipe. The pipe connecting structure has a simple structure, is convenient for disassembly and assembly, reduces the production cost and improves the assembly efficiency.

### BACKGROUND OF THE INVENTION

### 1. Field of the Invention

The present invention relates to pipe fittings, and more particularly to a pipe connecting structure.

### 2. Description of the Prior Art

Pipe fittings are components used in a piping system for connection, control, direction change, diversion, seal, and support. In the prior art, the connection between a plurality of pipes generally adopts a fixed connection or a detachable connection. The fixed connection, such as welding, bonding or hot melting, etc., is not beneficial for disassembly and assembly. The detachable connection, such as threaded fit, snap-on connection, etc., can achieve repeated disassembly and assembly, which is flexible and convenient. However, the existing detachable connecting structures are complicated, and most of them are disassembled and assembled by means of tools, which has the disadvantages of high production cost and low assembly efficiency. Accordingly, the inventor of the present invention has devoted himself based on his many years of practical experiences to solve these problems.

### SUMMARY OF THE INVENTION

The primary object of the present invention is to provide a pipe connecting structure, which has a simple structure, is convenient for disassembly and assembly, reduces the production cost and improves the assembly efficiency.

In order to achieve the above object, the present invention adopts the following technical solutions:

A pipe connecting structure for joining a first pipe having a limiting groove comprises a second pipe and a limiting member. One end of the second pipe is formed with a second connecting portion. The second connecting portion is provided with a receiving hole for receiving one end of the first pipe. The receiving hole is disposed along an axial direction of the second connecting portion and communicates with the second pipe. The limiting member includes a pressing portion and two elastic portions respectively connected to two sides of the pressing portion. The two elastic portions oppositely clamp an outer circumference of the second connecting portion. The limiting member has an opening formed between the two elastic portions. Opposing sides of the two elastic portions each have a first curved surface that matches the outer circumference of the second connecting portion. The limiting member is formed with an accommodating space. The accommodating space is located between one side of the first curved surface, away from the opening, and an inner side of the pressing portion. A junction of the side of the first curved surface and the accommodating space is formed with a limiting flange protruding from a side wall of the accommodating space. At least one of the first curved surfaces of the two elastic portions is provided with a limiting protrusion. The second connecting portion is formed with a side hole corresponding in position to the limiting protrusion. The side hole is in communication with the receiving hole. The limiting protrusion is inserted through the side hole to be engaged in the limiting groove.

Preferably, one end of the limiting protrusion is formed with a second curved surface matching a bottom of the limiting groove.

Preferably, each of the first curved surfaces of the two elastic portions is formed with the limiting protrusion.

Preferably, a surface of the limiting protrusion, facing the side hole, is provided with a guide slope.

Preferably, the limiting protrusion is formed at one end of the first curved surface.

Preferably, the end of the second pipe is provided with a second connecting member. One end of the second connecting member is connected to the second pipe, and another end of the second connecting member is formed with the second connecting portion. The second connecting portion is formed with a second through hole communicating with the receiving hole. The second through hole is disposed along the axial direction of the second connecting portion.

Preferably, two ends of the second connecting portion are formed with a first stop wall and a second stop wall, respectively. Two ends of the limiting member are connected to the first stop wall and the second stop wall, respectively.

Preferably, opposing surfaces of the first stop wall and/or the second stop wall each have a first slide groove. The first slide groove extends in a direction same as a moving direction of the limiting member. One end of the pressing portion is provided with a guide protrusion. The guide protrusion is movably fitted in the first slide groove.

Preferably, the second connecting portion is formed with a stopper corresponding in position to the opening of the limiting member.

Preferably, two sides of the stopper are formed with second slide grooves, and respective ends of the elastic portions are slidedly connected to the second slide grooves.

With the above structure, the invention only needs one limiting member to realize stable connection of the first pipe and the second pipe. The structure is simple, thereby achieving a decrease in production cost. The limiting protrusion is disposed on the first curved surface of the elastic portion, and the limiting protrusion is inserted through the side hole of the second connecting portion to be engaged in the limiting groove of the first pipe, thereby realizing the limit fit of the first pipe and the second pipe. The outer circumference of the second connecting portion presses the limiting flange to deform the elastic portion, that is, the positional relationship between the limiting protrusion and the limiting groove is changed, so as to complete the disassembly and assembly of the whole structure. Through the elasticity of the elastic portion, only the finger is required for operation. The operation is simple, without using a tool, thereby improving assembly efficiency.

### BRIEF DESCRIPTION OF THE DRAWINGS

FIG. 1 is a perspective view of a preferred embodiment of the present invention;

FIG. 2 is a cross-sectional view of the preferred embodiment of the present invention;

FIG. 3 is an exploded view of the preferred embodiment of the present invention;

FIG. 4 is a perspective view of the limiting member of the preferred embodiment of the present invention;

FIG. 5 is a schematic view showing the installation of the preferred embodiment of the present invention;

FIG. 6 is a schematic view of the preferred embodiment of the present invention in a locked state;

FIG. 7 is a schematic view of the preferred embodiment of the present invention in an unlocked state; and

FIG. 8 is a schematic view of the preferred embodiment of the present invention when in use.

### DETAILED DESCRIPTION OF THE PREFERRED EMBODIMENTS

Embodiments of the present invention will now be described, by way of example only, with reference to the accompanying drawings.

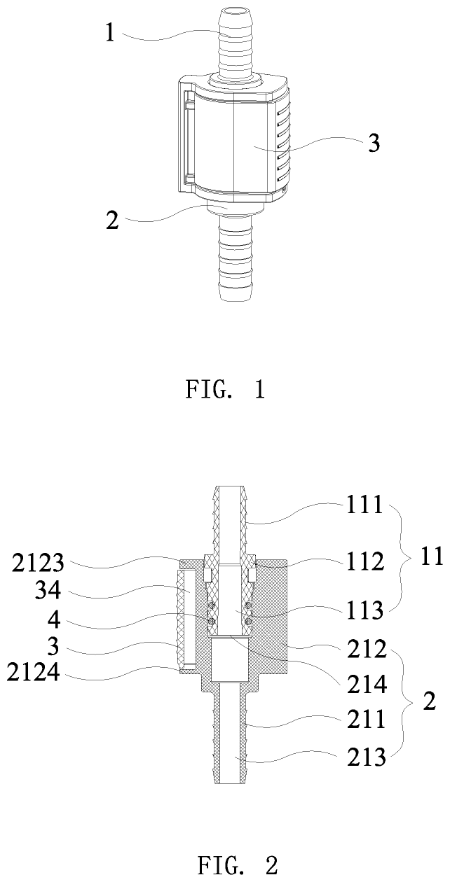

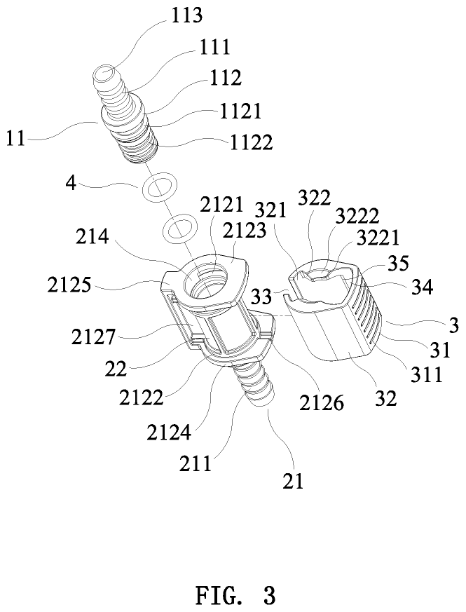

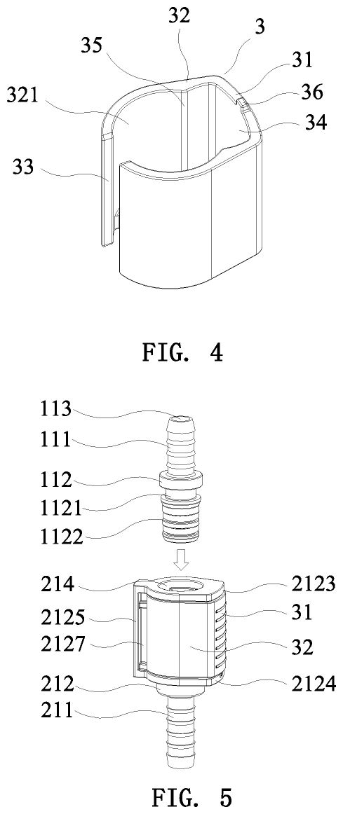

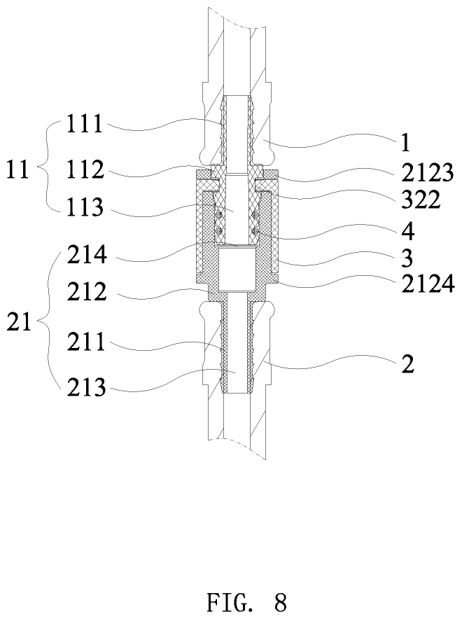

Referring to FIG. 1 through FIG. 8, the present invention discloses a pipe connecting structure for joining a first pipe 1, comprising a second pipe 2 and a limiting member 3. One end of the first pipe 1 is provided with a first connecting member 11. One end of the first connecting member 11 is formed with a first mounting portion 111 connected to the first pipe 1, and the other end is formed with a first connecting portion 112. The first connecting member 11 is formed with a first through hole 113. The first through hole 113 is disposed along the axial direction of the first connecting member 11 and penetrates the first mounting portion 111 and the first connecting portion 112.

One end of the second pipe 2 is provided with a second connecting member 21. One end of the second connecting member 21 is formed with a second mounting portion 211 connected to the second pipe 2, and the other end is formed with a second connecting portion 212. The second connecting member 21 is formed with a second through hole 213 and a receiving hole 214 that communicate with each other. Both the second through hole 213 and the receiving hole 214 are disposed along the axial direction of the second connecting member 21. The second through hole 213 is formed in the second mounting portion 211. The receiving hole 214 is formed in the second connecting portion 212. The first connecting portion 112 is sealedly fitted into the receiving hole 214.

The limiting member 3 includes a pressing portion 31 and two elastic portions 32 respectively connected to two sides of the pressing portion 31. The two elastic portions 32 oppositely clamp the outer circumference of the second connecting portion 212. The limiting member 3 has an opening 33 formed between the two elastic portions 32. The opposing sides of the two elastic portions 32 each have a first curved surface 321 that matches the outer circumference of the second connecting portion 212. The limiting member 3 is formed with an accommodating space 34. The accommodating space 34 is located between one side of the first curved surface 321, away from the opening 33, and the inner side of the pressing portion 31. The junction of the side of the first curved surface 321 and the accommodating space 34 is formed with a limiting flange 35 protruding from the side wall of the accommodating space 34. When the invention is installed, the second connecting portion 212 is disposed between the two elastic portions 32 through the opening 33. In an unlocked state, the pressing portion 31 is pressed by applying a force, and the limiting member 3 and the second connecting portion 212 are moved toward each other. That is, the second connecting portion 212 between the two first curved surfaces 321 is moved toward the pressing portion 31, and the limiting flanges 35 are pressed toward both sides, so that the second connecting portion 212 enters the accommodating space 34.

At least one of the first curved surfaces 321 of the two elastic portions 32 is provided with a limiting protrusion 322. The second connecting portion 212 is formed with a side hole 2121 corresponding in position to the limiting protrusion 322. The side hole 2121 is in communication with to the receiving hole 214. The first connecting portion 112 is formed with a limiting groove 1121 corresponding in position to the side hole 2121. The limiting protrusion 322 is inserted through the side hole 2121 to be engaged in the limiting groove 1121.

The limiting groove 1121 is formed in a circle along the circumferential direction of the first connecting portion 112, that is, the limiting groove 1121 is annular. Through the annular limiting groove 1121, the first connecting portion 112 may be inserted into the receiving hole 214 at any angle, and the limiting protrusion 322 is inserted in the limiting groove 1121 to facilitate installation. The outer circumference of the first connecting portion 112 is formed with at least one annular groove 1122. Each annular groove 1122 is provided with a sealing ring 4 therein. The sealing ring 4 is sealedly fitted between the outer circumference of the first connecting portion 112 and the side wall of the receiving hole 214, thereby ensuring the airtightness of the junction of the first through hole 113 and the second through hole 213. The outer circumference of the second connecting portion 212 is formed with at least an annular rib 2122. The rib 2122 is disposed along the circumferential direction of the second connecting portion 212 to facilitate the movement of the limiting flange 35 on the outer circumference of the second connecting portion 212.

One end of the limiting protrusion 322 is formed with a second curved surface 3221 matching the bottom of the limiting groove 1121. By providing the second curved surface 3221, the contact surface of the limiting protrusion 322 and the limiting groove 1121 is increased to ensure the stability of the limiting structure. The limiting protrusion 322 is formed at the end of the first curved surface 321, which is beneficial for demolding. Each of the two first curved surfaces 321 is formed with the limiting protrusion 322. The two limiting protrusions 322 pass through the side hole 2121 and are engaged in the limiting grooves 1121 on both sides of the first connecting portion 112, thereby further improving the stability of the limiting structure. The surface of the limiting protrusion 322, facing the side hole 2121, is provided with a guide slope 3222 for guiding the limiting protrusion 322 to be inserted in the side hole 2121 and the limiting groove 1121.

The outer side of the pressing portion 31 is a pressing surface, and a plurality of anti-slip stripes 311 are formed on the pressing surface.

Two ends of the second connecting portion 212 are formed with a first stop wall 2123 and a second stop wall 2124, respectively. Two ends of the limiting member 3 are connected to the first stop wall 2123 and the second stop wall 2124, respectively. The first stop wall 2123 and the second stop wall 2124 are configured to limit the mounting position and the moving direction of the limiting member 3 on the second connecting portion 212. The opposing surfaces of the first stop wall 2123 and/or the second stop wall 2124 each have a first slide groove 2126. The first slide groove 2126 extends in a direction same as the moving direction of the limiting member 3. One end of the pressing portion 31 is provided with a guide protrusion 36. The guide protrusion 36 is movably fitted in the first slide groove 2126.

In this embodiment, the second connecting portion 212 is formed with a stopper 2125 corresponding in position to the opening 33 of the limiting member 3. The stopper 2125 serves as a point of application of the finger when the invention is disassembled. Two sides of the stopper 2125 are formed with second slide grooves 2127. The ends of the elastic portions 32 are slidedly connected to the second slide grooves 2127. The moving direction of the ends of the elastic portions 32 is restricted by the second slide grooves 2127.

The first through hole 113 and the second through hole 213 function as a water supply passage.

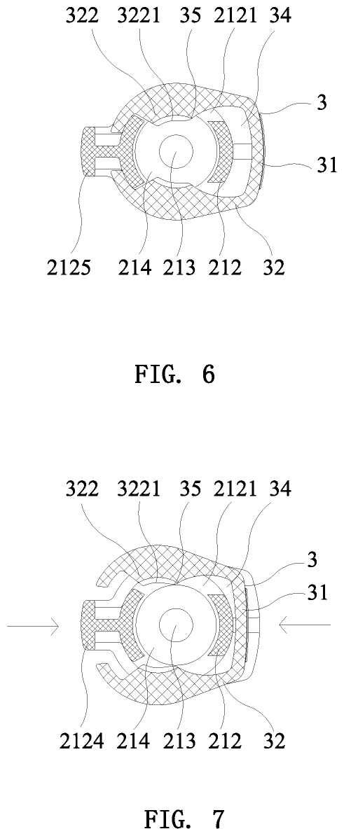

Referring to FIG. 5 and FIG. 6, when this embodiment is in a locked state, the limiting protrusion 322 of the limiting member 3 passes through the side hole 2121 and the side hole of the receiving hole 214 to be engaged in the limiting groove 1121, so that the first pipe 1 and the second pipe 2 won't disengage from each other.

Referring to FIG. 5 and FIG. 7, a force is applied to the pressing portion 31 of the limiting member 3 and the stopper 2125 of the second connecting portion 212 (that is, the pressing portion 31 of the limiting member 3 and the stopper 2125 of the second connecting portion 212 are pressed toward the middle of the second pipe 2 with two fingers), so that the limiting member 3 and the second connecting portion 212 are moved toward each other. The limiting flange 35 of the limiting member 3 is moved on the rib 2122 of the second connecting portion 212 to expand the two elastic portions 32 outwardly. The limiting protrusion 322 is disengaged from the receiving hole 214, and the invention is in an unlocked state. At this time, the first pipe 1 and the second pipe 2 can be separated to complete the disassembly of this embodiment.

With the above structure, the invention only needs one limiting member 3 to realize stable connection of the first pipe 1 and the second pipe 2. The structure is simple, thereby achieving a decrease in production cost. The limiting protrusion 322 is disposed on the first curved surface 321 of the elastic portion 32, and the limiting protrusion 322 is inserted through the side hole 2121 of the second connecting portion 212 to be engaged in the limiting groove 1121 of the first pipe 1, thereby realizing the limit fit of the first pipe 1 and the second pipe 2. The outer circumference of the second connecting portion 212 presses the limiting flange 35 to deform the elastic portion 32, that is, the positional relationship between the limiting protrusion 322 and the limiting groove 1121 is changed, so as to complete the disassembly and assembly of the whole structure. Through the elasticity of the elastic portion 32, only the finger is required for operation. The operation is simple, without using a tool, thereby improving assembly efficiency.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A pipe connecting structure for joining a first pipe having a limiting groove, comprising a second pipe and a limiting member; one end of the second pipe being formed with a second connecting portion, the second connecting portion being provided with a receiving hole for receiving one end of the first pipe, the receiving hole being disposed along an axial direction of the second connecting portion and communicating with the second pipe;
the limiting member including a pressing portion and two elastic portions respectively connected to two sides of the pressing portion, the two elastic portions oppositely clamp an outer circumference of the second connecting portion, the limiting member having an opening formed between the two elastic portions; opposing sides of the two elastic portions each having a first curved surface that matches the outer circumference of the second connecting portion; the limiting member being formed with an accommodating space, the accommodating space being located between one side of the first curved surface, away from the opening, and an inner side of the pressing portion, a junction of the side of the first curved surface and the accommodating space being formed with a limiting flange protruding from a side wall of the accommodating space; at least one of the first curved surfaces of the two elastic portions being provided with a limiting protrusion, the second connecting portion being formed with a side hole corresponding in position to the limiting protrusion, the side hole being in communication with the receiving hole; the limiting protrusion being inserted through the side hole to be engaged in the limiting groove.

2. The pipe connecting structure as claimed in claim 1, wherein one end of the limiting protrusion is formed with a second curved surface matching a bottom of the limiting groove.

3. The pipe connecting structure as claimed in claim 1, wherein each of the first curved surfaces of the two elastic portions is formed with the limiting protrusion.

4. The pipe connecting structure as claimed in claim 1, wherein a surface of the limiting protrusion, facing the side hole, is provided with a guide slope.

5. The pipe connecting structure as claimed in claim 1, wherein the limiting protrusion is formed at one end of the first curved surface.

6. The pipe connecting structure as claimed in claim 1, wherein the end of the second pipe is provided with a second connecting member; one end of the second connecting member is connected to the second pipe, another end of the second connecting member is formed with the second connecting portion; the second connecting portion is formed with a second through hole communicating with the receiving hole, and the second through hole is disposed along the axial direction of the second connecting portion.

7. The pipe connecting structure as claimed in claim 1, wherein two ends of the second connecting portion are formed with a first stop wall and a second stop wall respectively, and two ends of the limiting member are connected to the first stop wall and the second stop wall, respectively.

8. The pipe connecting structure as claimed in claim 7, wherein opposing surfaces of the first stop wall and/or the second stop wall each have a first slide groove, the first slide groove extends in a direction same as a moving direction of the limiting member, one end of the pressing portion is provided with a guide protrusion, and the guide protrusion is movably fitted in the first slide groove.

9. The pipe connecting structure as claimed in claim 1, wherein the second connecting portion is formed with a stopper corresponding in position to the opening of the limiting member.

10. The pipe connecting structure as claimed in claim 9, wherein two sides of the stopper are formed with second slide grooves, and respective ends of the elastic portions are slidedly connected to the second slide grooves.
